(19) United States
(12) Patent Application Publication
(10) Pub. No.: US 2021/0311191 A1
(43) Pub. Date: Oct. 7, 2021

(54) DISTANCE MEASUREMENT SENSOR AND DISTANCE MEASUREMENT METHOD

(71) Applicant: KOITO MANUFACTURING CO., LTD., Tokyo (JP)

(72) Inventor: Toru NAGASHIMA, Shizuoka-shi (JP)

(73) Assignee: KOITO MANUFACTURING CO., LTD., Tokyo (JP)

(21) Appl. No.: 17/332,107

(22) Filed: May 27, 2021

Related U.S. Application Data
(63) Continuation of application No. PCT/JP2019/045094, filed on Nov. 18, 2019.

(30) Foreign Application Priority Data
Nov. 30, 2018 (JP) 2018-225761

(51) Int. Cl. G01S 17/08; G02B 26/10; G01S 7/481; G02B 26/12

(52) U.S. Cl. CPC G01S 17/08; G02B 26/122; G01S 7/4817; G02B 26/105

(57) ABSTRACT

A scanning device includes a motor and a mirror attached to the motor and configured to reflect emitted light of a light source. The scanning device is configured to scan probe light, which is reflected light reflected by the mirror, according to the rotation of the motor. A photosensor detects return light, which is light reflected from a point on an object. A processor detects the distance to the point on the object based on the output of the photosensor. A distance measurement sensor changes the angular resolution according to the distance to the object.

### BACKGROUND

### 1. Technical Field

The present invention relates to a distance measurement technique.

### 2. Description of the Related Art

Candidates of vehicle sensors include Light Detection and Ranging, Laser Imaging Detection and Ranging (LiDAR), cameras, millimeter-wave radar, ultrasonic sonar, and so forth. In particular, LiDAR has advantages as compared with other sensors. Examples of such advantages include: (i) an advantage of being capable of recognizing an object based on point cloud data; (ii) an advantage in employing active sensing, which is capable of providing high-precision detection even in bad weather conditions; (iii) an advantage of providing wide-range measurement; etc. Accordingly, LiDAR is anticipated to become mainstream in vehicle sensing systems.

Currently, commercially available LiDARs have a problem of an extremely high cost. Accordingly, in some cases, it is difficult to employ such a high-cost LiDAR depending on the kind of automobile or the usage thereof.

### SUMMARY

The present disclosure has been made in view of such a situation.

An embodiment of the present disclosure relates to a distance measurement sensor. The distance measurement sensor includes: a light source; a scanning device including a motor and a mirror attached to the motor and structured to reflect emitted light of the light source, in which the scanning device is structured such that scan probe light, which is light reflected by the mirror, can be scanned according to the rotation of the motor; a photosensor structured to detect return light, which is the probe light reflected by an object; and a processor structured to detect the distance to a point on the object based on the output of the photosensor. The angular resolution in the scan direction is changed according to the distance to the object.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing a distance measurement sensor according to an embodiment;

FIG. 2 is a diagram showing point cloud data acquired with a constant angular resolution Δθ;

FIG. 3 is a diagram showing point cloud data acquired with a variable angular resolution Δθ;

FIGS. 4A and 4B are diagrams each showing a relation between the distance d to an object and the angular resolution Δθ;

FIG. 5 is a diagram showing a relation between the distance measurement range and the angular resolution Δθ;

FIG. 6 is a diagram showing an example of the control of the angular resolution Δθ;

FIG. 7 is a block diagram showing the distance measurement sensor according to an example 1;

FIG. 8 is a time chart showing the control of the angular resolution Δθ according to the example 1;

FIG. 9 is a time chart showing the control of the angular resolution Δθ according to an example 2;

FIG. 10 is a block diagram showing an automobile provided with the distance measurement sensor;

FIG. 11 is a block diagram showing an automotive lamp provided with the distance measurement sensor.

### DETAILED DESCRIPTION

### Overview of the Embodiments

An outline of several example embodiments of the disclosure follows. This outline is provided for the convenience of the reader to provide a basic understanding of such embodiments and does not wholly define the breadth of the disclosure. This outline is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later.

An embodiment disclosed in the present specification relates to a distance measurement sensor. The distance measurement sensor includes a light source, a scanning device, a photosensor, and a processor. The scanning device includes a motor and a mirror attached to the motor and structured to reflect emitted light of the light source. The scanning device is structured such that scan probe light, which is light reflected by the mirror, can be scanned according to the rotation of the motor. The photosensor detects return light that is the probe light reflected from a point on an object. The angular resolution in the scan direction is changed according to the distance to the object.

With this embodiment, the resolution in the scan direction (e.g., horizontal direction) is dynamically changed according to the distance to the object. This allows the shape of an object located at a farther position to be detected with high precision.

Also, the rotational speed of the motor may be changed according to the distance to the object. Instead of or in addition to such an arrangement, the distance measurement period may be changed according to the distance to the object.

Another embodiment of the present disclosure relates to an automotive lamp. The automotive lamp includes: any one from among the above-described distance measurement sensors; a variable light distribution lamp; and a controller structured to control the variable light distribution lamp according to the output of the distance measurement sensor.

### EMBODIMENTS

Description will be made below regarding the present disclosure based on preferred embodiments with reference to the drawings. The same or similar components, members, and processes are denoted by the same reference numerals, and redundant description thereof will be omitted as appropriate. The embodiments have been described for exemplary purposes only, and are by no means intended to restrict the present disclosure. Also, it is not necessarily essential for the present invention that all the features or a combination thereof be provided as described in the embodiments.

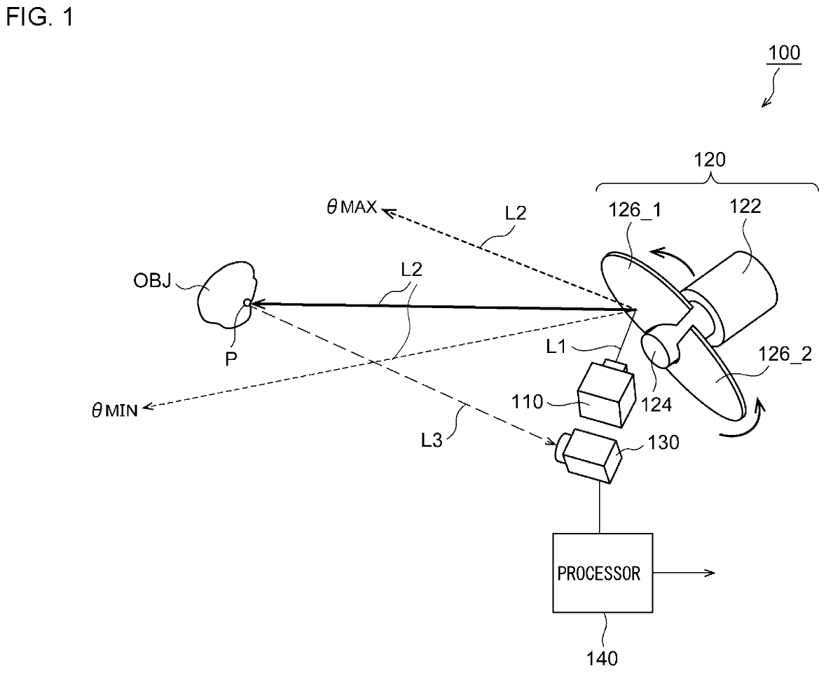

FIG. 1 is a block diagram showing a distance measurement sensor 100 according to an embodiment. The distance measurement sensor 100 is configured as a LiDAR (Light Detection and Ranging), including a light source 110, a scanning device 120, a photosensor 130, and a processor 140. The light source 110 emits light L1 having an infrared spectrum, for example. The emitted light L1 of the light source 110 may be modulated with respect to time.

The scanning device 120 includes a motor 122 and one or multiple mirrors (which will be also referred to as “blades”) 126. The mirrors 126 are configured to have a fan-shaped structure. The mirrors 126 are attached to a rotational shaft 124 of the motor 122 such that they reflect the emitted light L1 of the light source 110. The emission angle (which will also be referred to as a “scan angle”) θ of probe light L2, which is light reflected from the mirrors 126, changes according to the position of the mirrors 126 (i.e., rotational angle ϕ of the motor). Accordingly, by rotationally driving the motor 122, the probe light L2 can be scanned in the θ direction ranging between θ_{MIN} and θ_{MAX}. It should be noted that, in a case in which the number of mirrors 126 thus provided is two, one half-rotation of the motor 122 (mechanical angle of 180 degrees) corresponds to a single scan. Accordingly, the probe light L2 is scanned twice every time the motor 122 is rotated once. It should be noted that the number of the mirrors 126 is not restricted in particular.

The rotational angle ϕ of the motor 122 can be detected by means of a position detection mechanism such as a Hall sensor, optical encoder, or the like. Accordingly, the scan angle θ at each time point can be obtained based on the rotational angle ϕ.

The photosensor 130 detects return light L3 reflected at a point P on an object OBJ. The processor 140 detects the distance to the point P on the object OBJ based on the output of the photosensor 130. The distance detection method or algorithm is not restricted in particular. Rather, known techniques may be employed. For example, the delay time from the emission of the probe light L2 to the reception of the return light by means of the photosensor 130, i.e., the time of flight (TOF), may be measured so as to acquire the distance.

The above is the basic configuration of the distance measurement sensor 100. Next, description will be made regarding the operation thereof. The motor 122 is rotationally driven so as to change the scan angle θ of the probe light L2 in the order of θ₁, θ₂, . . . . In this operation, the distance rᵢ to the point Pᵢ on the surface of the object OBJ is measured at each scan angle θ₁ (i=1, 2, With this, data (point cloud data) formed of data pairs each configured as a pair of the scan angle θ₁ and the corresponding distance rᵢ, can be acquired.

With such a distance measurement sensor 100, the scanning device 120 can be configured as a combination of the motor 122 configured as a commonplace motor and the mirrors 126 arranged in a fan structure. This provides the distance measurement sensor 100 with a reduced cost.

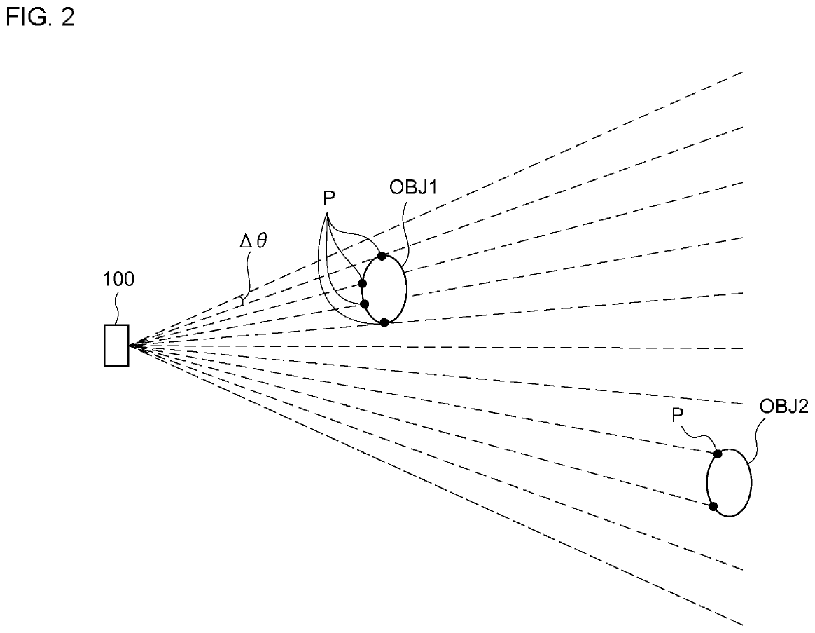

Next, description will be made regarding other features of the distance measurement sensor 100. FIG. 2 is a diagram showing the point cloud data acquired in measurement with a constant angular resolution Δθ. An object OBJ1 is located at a position that is relatively nearer to the distance measurement sensor 100. In contrast, an object OBJ2 is located at a position that is relatively farther from the distance measurement sensor 100.

In a case of measurement with a constant angular resolution Δθ, reflected light data is acquired for a relatively larger number of points P1 with respect to the object OBJ1 at a position nearer to the distance measurement sensor 100. However, as the distance to the object becomes larger, the number of the points P for which the reflected light data is acquired becomes smaller. That is to say, as the distance to the object becomes larger, the difficulty of judging its shape becomes higher.

In order to solve such a problem, an approach can be employed in which the angular resolution Δθ is designed to be very fine so as to provide sufficient resolution for an object at the farthest position within the distance measurement range of the distance measurement sensor 100. However, such an approach involves an enormous number of points of point cloud data acquired in a single scan. This requires the processor 140 to support an enormous amount of calculation, leading to reduction of the scanning rate. In order to provide the scanning rate required by an application, such an arrangement requires the processor 140 to be configured as a high-cost, high-performance processor. This does not meet a demand for the distance measurement sensor 100 to be provided with a low cost.

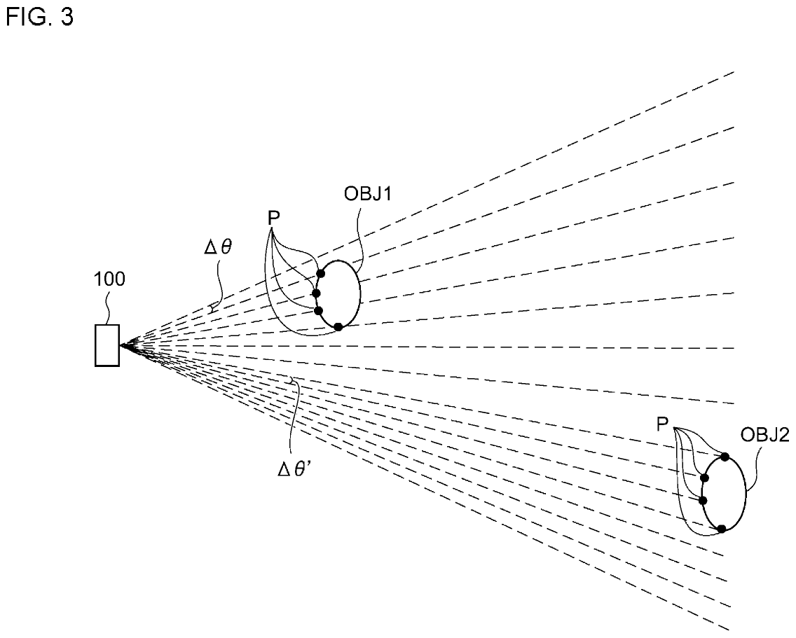

In order to solve such a problem, with the present embodiment, the angular resolution Δθ is designed to be dynamically changed according to the distance d to the object OBJ. FIG. 3 is a diagram showing the point cloud data acquired with a variable angular resolution Δθ. When the object OBJ2 to be measured is located at a farther position, the angular resolution Δθ is adjusted to a higher resolution. With this, reflected light data is acquired for four points with respect to the object OBJ2 at a farther position. This allows the shape judgement to be made even for the object OBJ2 located at a farther position.

From another viewpoint, when the object OBJ1 is located at a nearer position, the angular resolution Δθ is adjusted to a lower resolution so as to reduce the number of points of point cloud data. This allows the scanning rate required for an application to be supported even in a case of employing a low-cost, relatively low-performance processor as the processor 140.

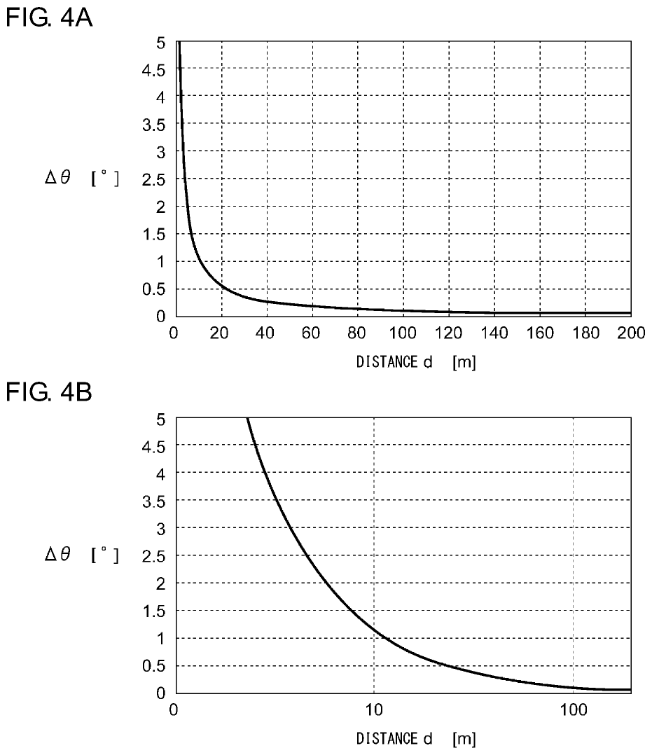

FIGS. 4A and 4B are diagrams each showing the relation between the distance d to the object and the angular resolution Δθ. For example, let us consider an example in which a spatial resolution of Δx is designed in the scan direction regardless of the distance d to the object. In this case, it is sufficient if the following Expression (1) is satisfied. Accordingly, the relation expression between Δθ and d is represented by Expression (2).

d·sin(Δθ)=Δx (1)

Δθ=arcsin(Δx/d) (2)

FIGS. 4A and 4B are diagrams each showing the relation between Δθ and d with Δx as 0.2 m. Specifically, FIG. 4 shows the relation with the horizontal axis as a linear scale. FIG. 4B shows the relation with the horizontal axis as a logarithmic scale.

The angular resolution Δθ may be held in the form of a function of the distance d, and the angular resolution Δθ may be calculated by the processor 140. Alternatively, a table that represents the relation between the distance d and the angular resolution Δθ may be held, and the angular resolution Δθ may be acquired by referring to the table.

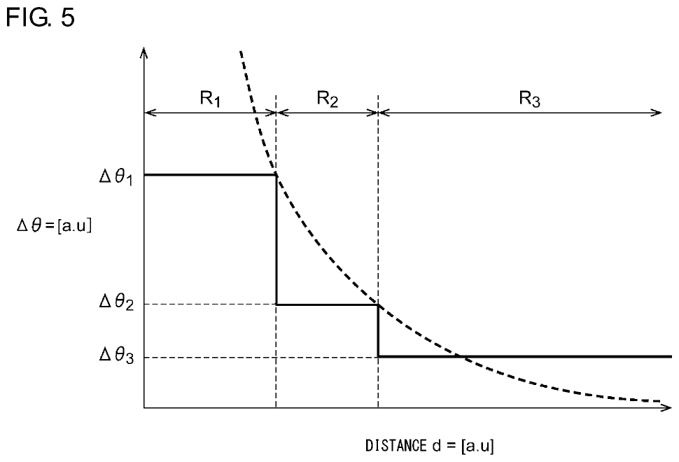

Instead of such an example as shown in FIGS. 4A and 4B in which the angular resolution Δθ is continuously changed according to the distance d to the object OBJ, the angular resolution Δθ may be changed in a discrete manner as described below. That is to say, the overall distance measurement range is divided into m multiple ranges R₁ through Rₘ, and the angular resolutions Δθ₁ through Δθₘ may be determined for each range. FIG. 5 is a diagram showing the relation between the distance measurement range and the angular resolution Δθ. FIG. 5 shows an example in which m=3. However, the number of the divided ranges is not restricted in particular. For example, the division number m may be 2 or 4 or more.

The distance d to the object OBJ can be detected based on the distance r to a typical point P on the surface of the object OBJ. As the typical point, the point at which the reflected light data was first acquired may be selected. Alternatively, multiple points may be selected as the typical points. In this case, the average value of the distances to the multiple typical points may be employed as the distance d to the object OBJ.

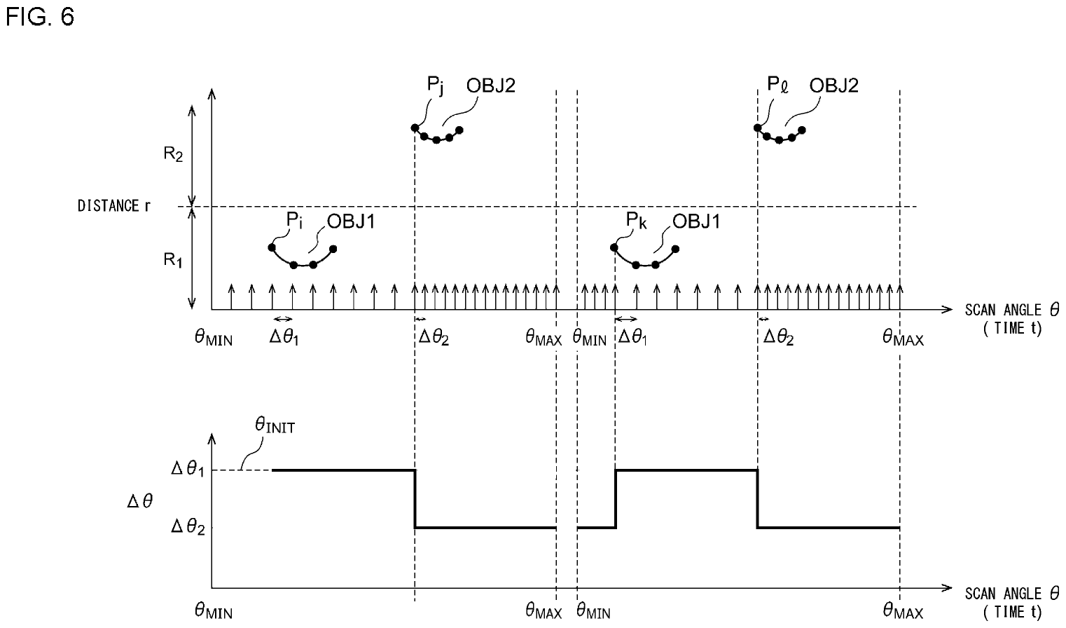

The resolution Δθ may be dynamically changed in one scanning period. For example, the angular resolution Δθ may be updated every time a new object OBJ is detected. FIG. 6 is a diagram showing an example of the control of the angular resolution Δθ. The horizontal axis represents the scan angle θ, which can be associated with the direction of time progression. The upper graph shows the distance r. The lower graph shows the angular resolution Δθ. FIG. 6 shows graphs over two scanning periods.

Let us consider a situation in which the object OBJ1 is positioned within the range R₁, and the object OBJ2 is positioned within the range R₂. Initially, the angular resolution Δθ is set to an initial value θ₀.

The distance rᵢ to the first point Pᵢ is measured on the object OBJ1. In this stage, assuming that the distance rᵢ is the same as the distance d1 to the object OBJ1, judgement is made that the object OBJ1 is positioned within the range R₁. Accordingly, after the angular resolution Δθ is set to a larger value Δθ₁, the scanning progresses.

Subsequently, the distance rⱼ to the first point Pⱼ is measured on the object OBJ2. In this stage, based on the distance rⱼ, i.e., assuming that the distance rⱼ is the same as the distance d2 to the object OBJ2, judgement is made that the object OBJ2 is positioned within the range R₂. Accordingly, after the angular resolution Δθ is set to a smaller value Δθ₂, the scanning progresses.

After the scan angle θ reaches θ_{MAX}, the measurement proceeds to the next scanning period. In this stage, the angular resolution Δθ is returned to θ_{MIN}.

The distance rₖ to the first point Pₖ is measured on the object OBJ1. In this stage, assuming that the distance rₖ is the same as the distance d1 to the object OBJ1, judgement is made that the object OBJ1 is positioned within the range R₁. Accordingly, after the angular resolution Δθ is set to Δθ₁, the scanning progresses.

Subsequently, the distance r₁ to the first point P₁ is measured on the object OBJ2. In this stage, based on the distance r₁, i.e., assuming that the distance r₁ is the same as the distance d2 to the object OBJ2, judgement is made that the object OBJ2 is positioned within the range R₂. Accordingly, after the angular resolution Δθ is set to Δθ₂, the scanning progresses.

It should be noted that, when significant reflected light data cannot be acquired in a given range, the angular resolution Δθ may be set to a larger value. This allows the number of points of the point cloud data to be reduced, thereby allowing the calculation load of the processor 140 to be reduced.

Next, description will be made with reference to several examples regarding a method for controlling the angular resolution Δθ.

### Example 1

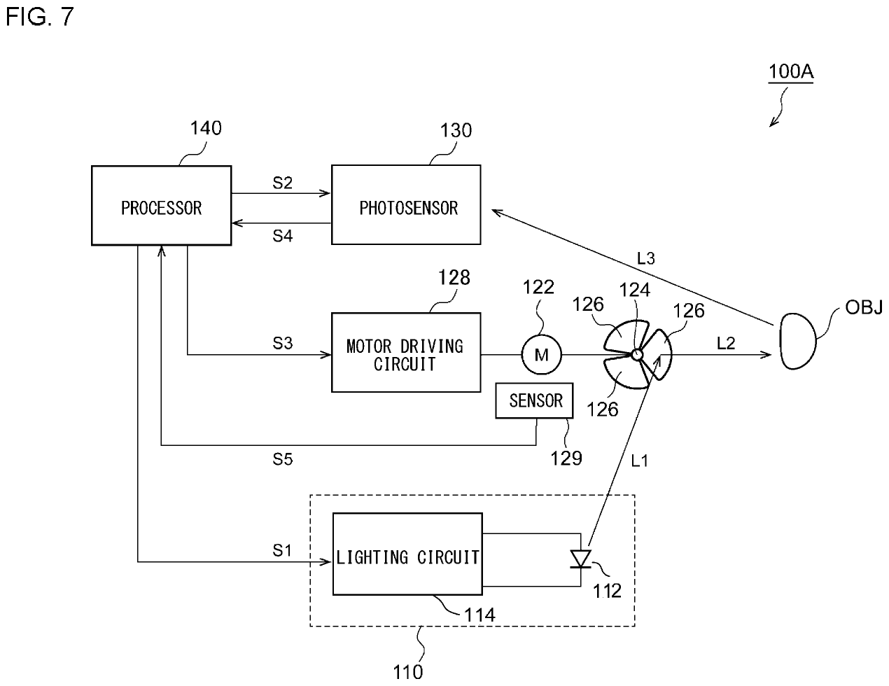

FIG. 7 is a block diagram showing a distance measurement sensor 100A according to an example 1. The distance measurement sensor 100A is configured to dynamically change the rotational speed of the motor 122 according to the distance d to the object OBJ.

The processor 140 supplies timing signals S1 and S2 to the light source 110 and the photosensor 130, respectively, in order to maintain the distance measurement period (sampling rate) Tr at a constant value.

The light source 110 includes a light-emitting element 112 and a lighting circuit 114. The lighting circuit 114 turns on the light-emitting element 112 in synchronization with the timing signal S1. The photosensor 130 measures the return light L3 in synchronization with the timing signal S2.

The processor 140 acquires the TOF based on an output S4 of the photosensor 130. The distance measurement sensor 100A may include a position sensor 129 that detects the position of a rotor of the motor 122 (rotational angle ϕ of the motor). The processor 140 may acquire the current scan angle θ based on an output S5 of the position sensor 129.

The processor 140 determines the angular resolution Δθ based on the distance d to the object OBJ. Subsequently, the processor 140 outputs a rotational speed command S3 that corresponds to the angular resolution Δθ to a motor driving circuit 128. The motor driving circuit 128 rotationally drives the motor 122 with a rotational speed that corresponds to the rotational speed command S3.

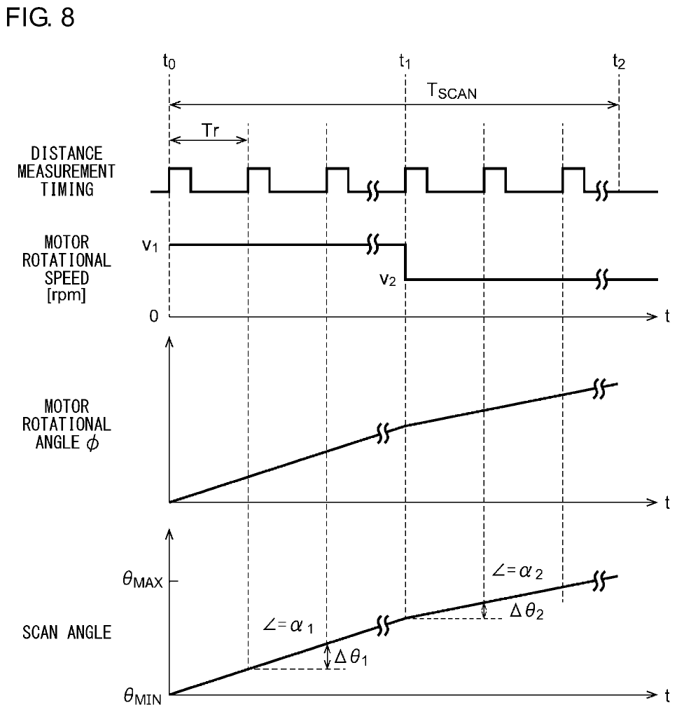

The above is the configuration of the distance measurement sensor 100A. Next, description will be made regarding the operation thereof. FIG. 8 is a time chart showing a control operation for controlling the angular resolution Δθ according to the example 1. A distance measurement timing occurs for every predetermined period Tr. During a period from t₀ to t₁, the motor rotational speed is set to a first value v₁. In this period, the rotational angle ϕ is changed with a first slope. For simplification of description, assuming that the scan angle changes in proportion to the motor rotational angle ϕ, the scan angle θ is increased with a given slope α₁. In this case, the angular resolution Δθ₁ is represented by α₁×Tr.

During the period from t₁ to t₂, the rotational speed of the motor is set to a second value v₂ that is smaller than the first value v₁. In this period, the motor rotational angle ϕ is changed with a second slope. In this case, the scan angle θ is increased with a relatively small slope α₂ (<α₁). The corresponding angular resolution Δθ₂ is represented by α₂×Tr.

As described above, with the example 1, by controlling the motor rotational speed, the angular resolution Δθ can be controlled.

It should be noted that a stepping motor is employed as the motor 122. In this case, the processor 140 is able to control the rotational speed according to the frequency of pulses supplied to the motor 122. Specifically, this arrangement allows the rotational angle to be controlled according to the number of pulses thus supplied. With such an arrangement employing such a stepping motor, an open-loop control operation can be supported, thereby allowing the position sensor 129 to be omitted.

### Example 2

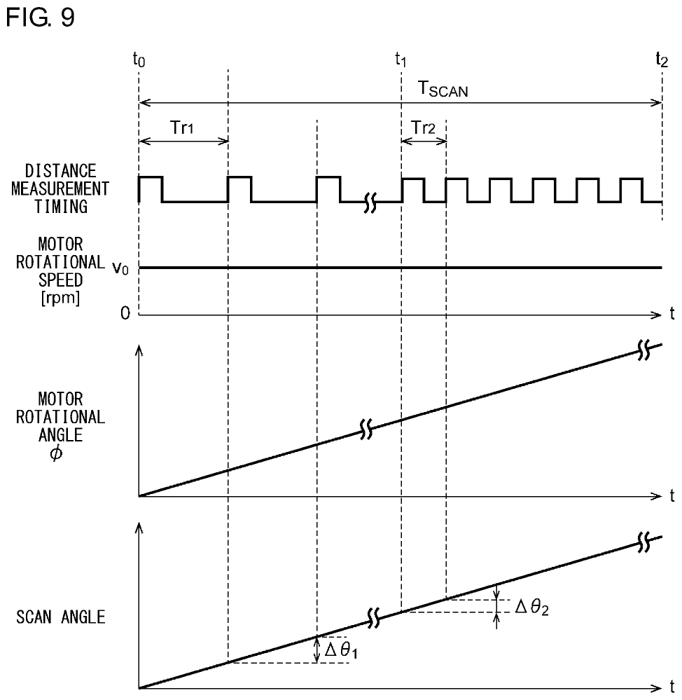

In an example 2, the distance measurement sensor 100 is configured to change the distance measurement period Tr while maintaining the motor rotational speed at a constant value. FIG. 9 is a time chart with respect to the control operation for controlling the angular resolution Δθ according to the example 2.

The motor rotational speed is maintained at a constant value v₀ over the entire scanning period T_{SCAN}. Accordingly, the scan angle θ is increased with a constant slope α₀.

During a period from t₀ to t₁, the distance measurement period Tr is set to a relatively long period, i.e., a first value Trᵢ. In this period, the angular resolution Δθ₁ is represented by α₀×Tr₁.

During a period from t₁ to t₂, the distance measurement period Tr is set to a relatively short period, i.e., a second value Tr₂. In this period, the angular resolution Δθ₂ is represented by α₀×Tr₂.

As described above, by changing the distance measurement period Tr, the angular resolution Δθ can be controlled.

### Example 3

An example 3 is configured as a combination of the examples 1 and 2. Specifically, both the motor rotational speed and the distance measurement period Tr are changed. This allows the angular resolution Δθ to be adjusted.

### Usage

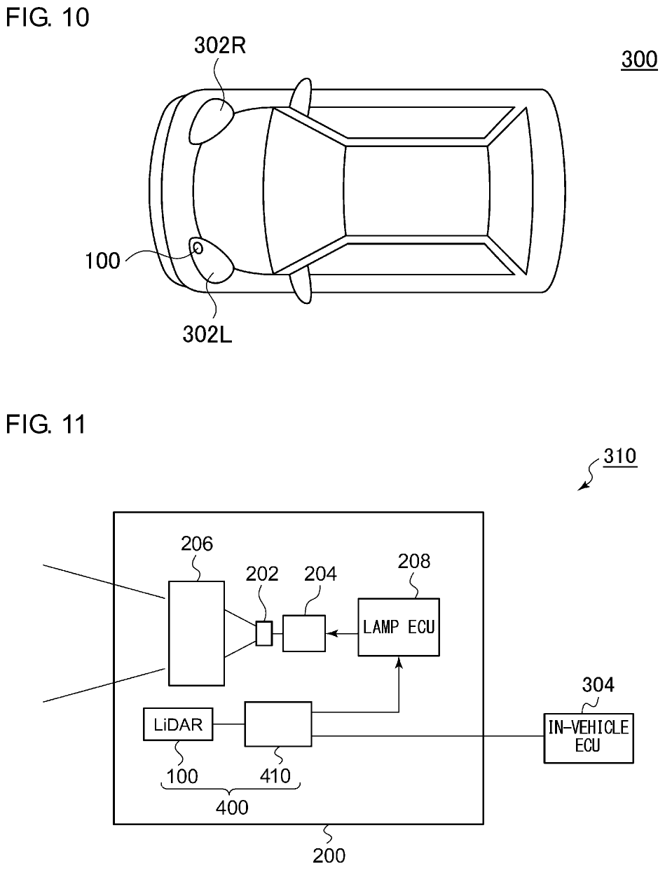

FIG. 10 is a block diagram showing an automobile provided with the distance measurement sensor 100. An automobile 300 is provided with headlamps 302L and 302R. At least one from among the headlamps 302L and 302R is provided with the distance measurement sensor 100 as a built-in component. Each headlamp 302 is positioned at a frontmost end of the vehicle body, which is most advantageous as a position where the distance measurement sensor 100 is to be installed for detecting an object in the vicinity.

FIG. 11 is a block diagram showing an automotive lamp 200 including the distance measurement sensor 100. The automotive lamp 200 forms a lamp system 310 together with an in-vehicle ECU 304. The automotive lamp 200 includes a light source 202, a lighting circuit 204, and an optical system 206. Furthermore, the automotive lamp 200 is provided with an object detection system 400. The object detection system 400 includes the above-described distance measurement sensor 100 and a processing device 410. The processing device 410 judges the presence or absence and the kind of an object OBJ in front of the vehicle based on point cloud data acquired by the distance measurement sensor 100. The processing device 410 may include an identifying device that operates based on a trained model acquired by machine learning.

Also, the information with respect to the object OBJ detected by the processing device 410 may be used to support the light distribution control operation of the automotive lamp 200. Specifically, a lamp ECU 208 generates a suitable light distribution pattern based on the information with respect to the kind of the object OBJ and the position thereof thus generated by the processing device 410. The lighting circuit 204 and the optical system 206 operate so as to provide the light distribution pattern generated by the lamp ECU 208.

Also, the information with respect to the object OBJ detected by the processing device 410 may be transmitted to the in-vehicle ECU 304. The in-vehicle ECU may support autonomous driving based on the information thus transmitted.

Description has been made above regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

### Modification 1

Description has been made in the embodiment regarding the distance measurement sensor 100 that supports a single scan line. Also, the distance measurement sensor 100 may support multiple scan lines.

### Modification 2

Description has been made in the embodiment regarding an example in which the angular resolution Δθ is designed such that the spatial resolution Δx in the scan direction is maintained to be as uniform as possible regardless of the distance d to the object. However, the present invention is not restricted to such an example. Also, the spatial resolution Δx may be designed to be changed according to the distance d to the object.

### Example 3

Description has been made in the embodiment regarding an example in which the distance measurement sensor 100 is mounted on a lamp as an example application of the distance measurement sensor 100. However, the usage of the distance measurement sensor 100 is not restricted to such an example. Rather, the distance measurement sensor 100 is applicable to various kinds of usages that do not require the level of performance of high-cost commercially available LiDAR.

Description has been made regarding the present invention with reference to the embodiments using specific terms. However, the above-described embodiments show only an aspect of the mechanisms and applications of the present invention. Rather, various modifications and various changes in the layout can be made without departing from the spirit and scope of the present invention defined in appended claims.

What is claimed is:

1. A distance measurement sensor comprising:
a light source;
a scanning device comprising a motor and a mirror attached to the motor and structured to reflect emitted light of the light source, wherein the scanning device is structured such that scan probe light, which is light reflected by the mirror, can be scanned according to a rotation of the motor;
a photosensor structured to detect return light, which is the probe light reflected from a point on an object; and
a processor structured to detect a distance to the point on the object based on an output of the photosensor,
wherein an angular resolution in a scan direction is changed according to a distance to the object.

2. The distance measurement sensor according to claim 1, wherein a rotational speed of the motor is changed according to the distance to the object.

3. The distance measurement sensor according to claim 1, wherein a distance measurement period is changed according to the distance to the object.

4. The distance measurement sensor according to claim 1, wherein the angular resolution is changed in a discrete manner according to the distance to the object.

5. The distance measurement sensor according to claim 1, wherein the angular resolution is controlled for every detected object.

6. An automotive lamp comprising:
the distance measurement sensor according to claim 1;
a variable light distribution lamp; and
a controller structured to control the variable light distribution lamp according to an output of the distance measurement sensor.

7. A distance measurement method comprising:
rotating a motor to which a mirror is attached;
irradiating light to the mirror so as to scan light reflected from the mirror;
detecting, by means of a photosensor, return light which is light reflected from an object;
detecting, by calculation, a distance to a point on the object based on an output of the photosensor; and
changing an angular resolution according to the distance to the object.
